(19) United States
(12) Patent Application Publication
(10) Pub. No.: US 2009/0285517 A1
(43) Pub. Date: Nov. 19, 2009

(54) DRIVE FACILITY

(76) Inventors: Ulrich Eckel, Rottenbach (DE); Stephan Schaufele, Erlangen (DE); Sebastian Waider, Petersberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/436,995

(22) Filed: May 7, 2009

(30) Foreign Application Priority Data
May 15, 2008 (EP) 08009028.5

(51) Int. Cl. F16C 33/58

(52) U.S. Cl. 384/513

(57) ABSTRACT

A drive facility having an electric motor and a bearing arranged outside the motor for coupling a load shaft to a engine shaft of the electric motor is disclosed. The bearing has an outer ring, an inner ring and several rolling elements which are arranged between the outer ring and inner ring. An axial and a radial force are transmitted by the bearing from the load shaft onto the electric motor. The outer ring of the bearing is connected to a stationary component of the electric motor. The inner ring of the bearing is connected to a rotating component of the motor and is connectable to the load shaft. A torque generated by the motor is transmitted from the engine shaft to the inner ring.

### CROSS REFERENCE TO RELATED APPLICATIONS

This application claims priority of European Patent Application No. 08009028.5 EP filed May 15, 2008, which is incorporated by reference herein in its entirety.

### FIELD OF INVENTION

The invention relates to a drive facility.

### BACKGROUND OF INVENTION

DE 103 57 884 A1 and DE 103 20 599 A1 disclose drive facilities for driving loads, in which a coupling is realized between a load shaft of a load to be driven and the engine shaft of an electrical motor with the aid of a complexly structured coupling facility. The design of the conventional connection which can be realized by means of such coupling facilities between the engine shaft and the load shaft is, as already mentioned, complexly structured, resulting in a correspondingly large installation size. Furthermore, coupling facilities integrated into the motor are also disclosed in DE 102 30 876 B3 for instance.

Coupling facilities known from the prior art are disadvantageous in that they can only be maintained with difficulty and effort. Exchanging the coupling facilities is in particular very time-consuming.

So-called threepart bearings are however also known from the internet page www.imo.de/Drehverbindungen.772.0.html by the company IMO. These are characterized in that they can bear both axial as well as radial forces and have a seal which seals the outer ring against the inner ring of the bearing.

### SUMMARY OF INVENTION

An object underlying the invention is to create a drive facility, which has a simply structured coupling facility for coupling a load shaft, which can be rapidly exchanged.

This object is achieved by a drive facility, with the drive facility comprising an electrical motor and a bearing arranged outside the motor for coupling a load shaft to an engine shaft of the motor, with the bearing having an outer ring, an inner ring and several rolling elements, which are arranged between the outer ring and the inner ring, with the bearing being embodied such that an axial and a radial force can be transmitted by the bearing from the load shaft to the motor, with the outer ring of the bearing being connected to a stationary component of the motor, with the inner ring of the bearing being connected to a rotating component of the motor, with the inner ring of the bearing being connectable to the load shaft, with a torque generated by the motor being transmitted from the engine shaft onto the inner ring.

Advantageous embodiments of the invention result from the dependent claims.

It has proven advantageous for the outer ring to be sealed off from the inner ring. It is herewith possible to dispense with the use of additional components which are attached to the bearing for sealing purposes.

It has also proven advantageous for the inner ring on the side facing the load shaft to have a geometric arrangement for the form-fit connection of the inner ring with the load shaft. A connection between the load shaft and the inner ring is herewith realized in a particularly simple fashion.

It has proven advantageous for the geometric arrangement for the form-fit connection of the inner ring with the load shaft to be embodied as toothing. One embodiment of the geometric arrangement as toothing provides a particularly simple embodiment.

It has also proven advantageous for the motor on the side of the motor facing the bearing not to have a bearing for mounting the engine shaft inside the motor. The components needed to assemble the motor can herewith be reduced.

It has also proven advantageous for the motor, on the side of the motor facing away from the bearing, to have a loose bearing for mounting the engine shaft. Since the bearing arranged outside the motor can bear axial forces, the bearing needed to mount the engine shaft can be embodied as a loose bearing on the side of the motor facing away from the bearing.

It has also proven advantageous for the outer ring of the bearing to be connected to the stationary component of the motor by means of screws passing through the outer ring. The bearing can then be assembled and disassembled particularly quickly.

It has also proven advantageous for the inner ring of the bearing to be connected to the stationary component of the motor by means of screws passing through the inner ring. The bearing can then be assembled and disassembled particularly quickly.

It has also proven advantageous for the inner ring of the bearing to be connected to a disk, with the axial force being transferable from the load shaft via the disk to the inner ring. This enables a particularly simple exchange of the load shaft.

It has also proven advantageous for a machine tool, production machine and/or a robot to be embodied with the drive facility according to the invention.

### BRIEF DESCRIPTION OF THE DRAWINGS

An exemplary embodiment of the invention is shown in the drawing and is shown in more detail below, in which:

FIG. 1 shows an embodiment of the drive facility according to the invention, which is connected to a load shaft and

2 shows a further embodiment of the drive facility according to their invention, which is connected to a load shaft.

### DETAILED DESCRIPTION OF INVENTION

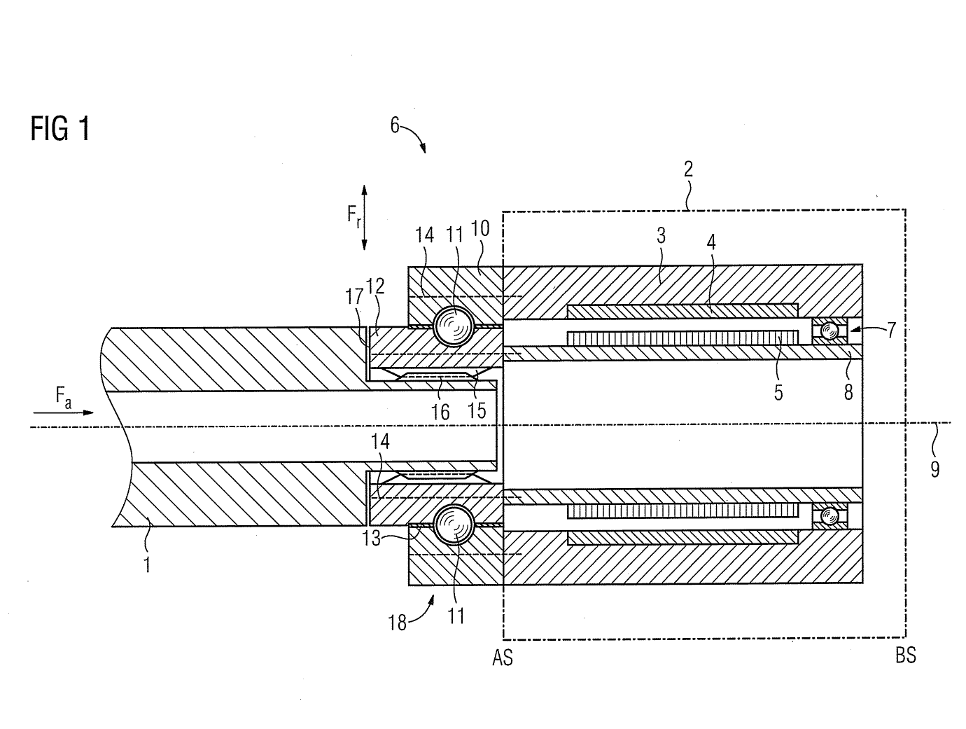

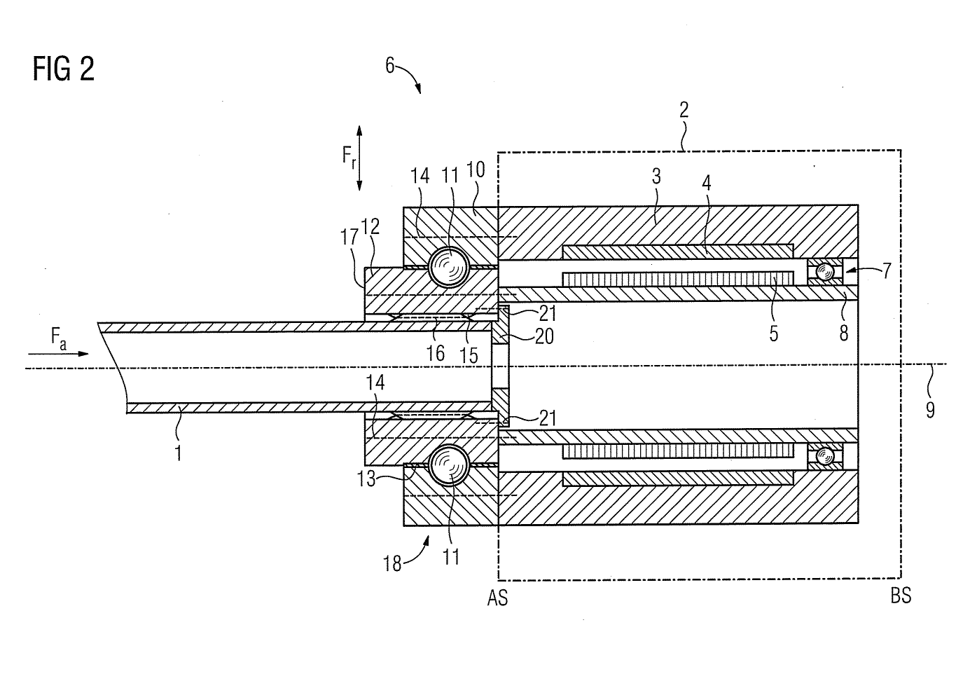

FIG. 1 shows a schematic representation of a drive facility 6, which is connected to a load shaft 1. The conventionally known coupling facility is realized in order to couple the load shaft 1 to the engine shaft 8 of a motor 2 in the form of a bearing 18. The coupling is realized as such using a bearing arranged outside the motor 2.

The bearing 18 has an outer ring 10, an inner ring 12 and several rolling elements 11, which are embodied as balls within the scope of the exemplary embodiment. The outer ring 10 is sealed off from the inner ring 12 by means of one individual or several seals 13, so that no lubricating liquid can leave the bearing from the rolling elements. Additional sealing components can herewith be dispensed with outside the bearing.

The outer and inner rings almost completely enclose the rolling elements. The bearing can transmit both an axial force Fₐ as well as a radial force Fᵣ from the load shaft 1 onto the motor 2 in respect of an axis of rotation 9. The axial force Fₐ and the radial force Fᵣ are exerted here, e.g. by a load (not shown in FIG. 1 for reasons of clarity), onto the load shaft when operating the drive facility, which is connected to the load.

The inner ring 12 has a geometric arrangement adjusted to the load shaft 1 on the side facing the load shaft for the form-fit connection of the load shaft with the inner ring. The geometric arrangement can be embodied as a toothing 15 for instance. The load shaft 1 has counter teeth 16 adjusted accordingly to the toothing 15. Alternatively, however, other connection techniques are also conceivable here.

The drive facility 6 also has a motor 2, with the components belonging to the motor 2 being framed in FIG. 2 by means of a dot and dash line. The motor 2 has a stationary component, which is embodied within the scope of the exemplary embodiment as a motor housing 3. A stator 4 of the motor 2 is connected to the motor housing 3. The motor 2 also has the engine shaft 8, which is embodied as a hollow shaft within the scope of the exemplary embodiment. The engine shaft 8 is connected to a rotor 5. The motor 2 has a loose bearing for mounting the engine shaft 8 on the side BS of the motor 2 facing away from the bearing 18.

Within the scope of the exemplary embodiment, on the side AS of the motor 2 facing the bearing, the motor 2 has no bearing inside the motor for mounting the engine shaft, since the bearing of the engine shaft 8 is realized on this side of the motor by means of the bearing 18.

Within the scope of the exemplary embodiment, the outer ring 10 is directly connected to a stationary component of the motor 2, i.e. in the exemplary embodiment is directly connected to the motor housing 3, by means of which screws 14 passing through the outer ring 10 are directly connected to the motor housing 3. The inner ring 12 of the bearing 18 is also directly connected to a rotating component of the motor within the scope of the exemplary embodiment, said rotating component being formed by the engine shaft 8 within the scope of the exemplary embodiment, and is directly connected to the engine shaft 8 by means of screws 19 passing through the inner ring 12.

The torque generated by the motor 2 is transmitted from the engine shaft 8 onto the inner ring 12. As a result, the torque generated in the motor 2 is transmitted from the engine shaft 8 via the inner ring 12 to the load shaft 1.

A force-fit connection for transmitting the torque of the motor via the inner ring 12 to the load shaft 1 is ensured with the aid of the form-fit connection between the inner ring and the load shaft. The transmission of the axial forces from the load shaft 1 takes place via the bearing surface 17 of the inner ring 12, with a small gap being shown for reasons of clarity in FIG. 1 between the bearing surface 17 and the load shaft 1, said small gap disappearing however when the axial forces appear. The coupling of the load shaft 1 to the engine shaft 8 is realized by means of the bearing 18. The otherwise conventional, complexly structured coupling facility is realized by the bearing 18. The bearing 18 weighs significantly less compared with conventionally used coupling facilities and allows a simple assembly and can be replaced quickly and easily. A routine test of the motor 2 and bearing 18 can take place at the engine manufacturers, with the intermediate step of the routine test which is necessary in the case of conventional coupling facilities no longer being necessary in the case of a drive manufacturer.

The bearing is generally embodied here in particular such that an axial force Fₐ of greater than 20 kN and a radial force Fᵣ of greater than 1.5 kN can be transmitted by the bearing. The axial and radial force which can be transmitted by the bearing can however also be smaller or larger in each instance.

FIG. 2 shows a further embodiment of the invention. The embodiment shown in FIG. 2 essentially corresponds in terms of basic structure to the embodiment described previously in FIG. 1. The same elements are thus provided in FIG. 2 with the same reference characters as in FIG. 1. The main difference is that, thanks to a corresponding embodiment of the load shaft holder, by means the disk 20, the load shaft can also be assembled and disassembled through the engine shaft 8 of the motor embodied as a hollow shaft, and passed through the motor shaft 8. The disk 20 is connected here via screws 21 to the inner ring 12. The axial force Fₐ is transmitted from the load shaft 1 via the disk 20 onto the inner ring 12. The diameter of the load shaft 1 has to be smaller here than the diameter of the engine shaft 8. This type of assembly and disassembly of the load shaft 1 has proven particularly advantageous in the case of extruder main drives.

The invention creates a drive facility 6 within the scope of the exemplary embodiments, with the drive facility comprising an electrical motor 2 and a bearing arranged outside the motor 2 for coupling a load shaft 1 to an engine shaft 8 of the motor 2, with the bearing 18 having an outer ring 10, an inner ring 12 and several rolling elements 11, which are arranged between the outer ring 10 and the inner ring 12, with the bearing 18 being embodied such that an axial and a radial force can be transmitted by the bearing 18 from the load shaft 1 onto the motor 2, in particular onto the motor housing 3 of the motor 2, with the outer ring 10 of the bearing 18 being directly connected to a stationary component 3 of the motor 2, with the inner ring 12 of the bearing 18 being directly connected to a rotating component 8 of the motor 2, with the inner ring 12 of the bearing 7 being directly connectable to the load shaft 1, with a torque generated by the motor 2 being transmitted from the engine shaft 8 onto the inner ring 12.

1.-10. (canceled)

11. A drive facility, comprising:
an electric motor having an engine shaft, a stationary component and a rotating component;
a load shaft; and
a bearing arranged outside the motor for coupling the load shaft to the engine shaft of the electric motor, the bearing having an outer ring, an inner ring and several rolling elements, the rolling elements being arranged between the outer ring and the inner ring,
wherein the bearing transmits an axial force and a radial force from the load shaft onto the motor,
wherein the outer ring of the bearing is connected to the stationary component of the electric motor,
wherein the inner ring of the bearing is connected to the rotating component of the electric motor and is connectable to the load shaft, and
wherein a torque generated by the electric motor is transmitted from the engine shaft onto the inner ring.

12. The drive facility as claimed in claim 11, wherein the outer ring is sealed off from the inner ring.

13. The drive facility as claimed in claim 11, wherein the inner ring has a geometric arrangement for the form-fit connection of the inner ring to the load shaft on the side facing the load shaft.

14. The drive facility as claimed in claim 12, wherein the inner ring has a geometric arrangement for the form-fit connection of the inner ring to the load shaft on the side facing the load shaft.

15. The drive facility as claimed in claim 13, wherein the geometric arrangement for the form-fit connection of the inner ring to the load shaft is embodied as toothing.

16. The drive facility as claimed in claim 14, wherein the geometric arrangement for the form-fit connection of the inner ring to the load shaft is embodied as toothing.

17. The drive facility as claimed in claim 11, wherein on a side of the electric motor facing the bearing, the electric motor has no bearing inside the electric motor for mounting the engine shaft.

18. The drive facility as claimed in claim 11, wherein the electric motor has a loose bearing for mounting the engine shaft on the side of the motor facing away from the bearing.

19. The drive facility as claimed in claim 11, wherein the outer ring of the bearing is connected to the stationary component of the motor by screws passing through the outer ring.

20. The drive facility as claimed in claim 11, wherein the inner ring of the bearing is connected to the rotating component of the electric motor by screws passing through the inner ring.

21. The drive facility as claimed in claim 11, wherein the inner ring of the bearing is connected to a disk, with the axial force being transferred from the load shaft via the disk onto the inner ring.

22. A tool machine, production machine or robot, comprising:
a drive facility, comprising:
an electric motor having an engine shaft, a stationary component and a rotating component;
a load shaft; and
a bearing arranged outside the motor for coupling the load shaft to the engine shaft of the electric motor, the bearing having an outer ring, an inner ring and several rolling elements, the rolling elements being arranged between the outer ring and the inner ring,
wherein the bearing transmits an axial force and a radial force from the load shaft onto the motor,
wherein the outer ring of the bearing is connected to the stationary component of the electric motor,
wherein the inner ring of the bearing is connected to the rotating component of the electric motor and is connectable to the load shaft, and
wherein a torque generated by the electric motor is transmitted from the engine shaft onto the inner ring.

23. The tool machine, production machine or robot as claimed in claim 22, wherein the outer ring is sealed off from the inner ring.

24. The tool machine, production machine or robot as claimed in claim 22, wherein the inner ring has a geometric arrangement for the form-fit connection of the inner ring to the load shaft on the side facing the load shaft.

25. The tool machine, production machine or robot as claimed in claim 24, wherein the geometric arrangement for the form-fit connection of the inner ring to the load shaft is embodied as toothing.

26. The tool machine, production machine or robot as claimed in claim 22, wherein on a side of the electric motor facing the bearing, the electric motor has no bearing inside the electric motor for mounting the engine shaft.

27. The tool machine, production machine or robot as claimed in claim 22, wherein the electric motor has a loose bearing for mounting the engine shaft on the side of the motor facing away from the bearing.

28. The tool machine, production machine or robot as claimed in claim 22, wherein the outer ring of the bearing is connected to the stationary component of the motor by screws passing through the outer ring.

29. The tool machine, production machine or robot as claimed in claim 22, wherein the inner ring of the bearing is connected to the rotating component of the electric motor by screws passing through the inner ring.

30. The tool machine, production machine or robot as claimed in claim 22, wherein the inner ring of the bearing is connected to a disk, with the axial force being transferred from the load shaft via the disk onto the inner ring.
